(19) United States
(12) Patent Application Publication
(10) Pub. No.: US 2010/0188715 A1
(43) Pub. Date: Jul. 29, 2010

(54) Method of Making Holograms Having at Least Two Replay Colours

(76) Inventors: Satyamoorthy Kabilan, Cambridge (GB); Stephen Terrell, Cambridge (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/161,250

(22) PCT Filed: Jan. 17, 2007
(86) PCT No.: PCT/GB2007/000137

§ 371 Date: Jan. 10, 2009

(30) Foreign Application Priority Data
Jan. 18, 2006 (GB) 0601016.9
Feb. 10, 2006 (GB) 0602746.0

(51) Int. Cl. G02B 5/32; G03H 1/26; B42D 15/10; B44F 1/00; B32B 37/00

(52) U.S. Cl. 359/2; 359/22; 359/15; 156/60

(57) ABSTRACT

A method of making a product containing a hologram which has at least two replay colours when viewed at a given angle, the method comprising the steps of: (i) recording holographic elements at each of at least two different angles in a master; and (ii) copying the master. The principle of the system is demonstrated by creating 2 surface relief objects, A and B on top of a mirror background. When a holographic recording medium is placed on top of this surface relief object and then illuminated with a coherent laser beam, interference patterns are recorded and developed within the polymer which describe the relief patterns (C-E). When the hologram is illuminated with white light and viewed normal to the hologram surface, the separation between the fringes relative to the viewing angle then becomes da and dc for surface relief objects A and B respectively (Figures C and E) and remains the same for the mirror (Figure D). This will then result in different frequencies of light or different colours being reflected at each specific viewing angle.

### FIELD OF THE INVENTION

The present invention concerns methods of making holograms having at least two replay colours when viewed from a given angle, and to holograms obtainable by such a method.

### BACKGROUND TO THE INVENTION

Holograms that have multiple colours are highly desirable, both for aesthetic reasons and in the field of security.

Holographic security labels are currently manufactured in large quantities using embossed foil mass-production techniques. A variety of levels of security are provided by a combination of multiple images, image complexity, multiple illumination formats, messages, coded messages, overt images, covert images and label removal prevention. It is also known to use holograms having multiple colours in this context, which are near impossible to forge using a single laser, and very difficult to forge even with multiple lasers of differing frequencies.

WO05/122099 discloses methods for making various types of holograms for use in security applications, including multicoloured holograms. In WO05/122099, holograms with different colour images or a gradient of colour images are produced by using particular polymers that undergo swelling in a well defined manner under certain conditions, and controlling the swelling state of the polymer material during the recording process. This is achieved by pre-swelling/pre-contracting the polymer in different solvents, moisture, heat, pressure or chemicals before recording the hologram or by chemically selectively hardening or softening areas of the polymer.

Images of different colours are superimposed onto one another by recording them at different swelling states of the polymer. The extent of the swelling of the polymer during recording will determine the replay of colour of the holographic image when the hologram is dry.

EP1244902 relates to multiplexed holographic images and also teaches that the different images must be recorded separately, namely by exposing a photosensitised polymer film to a sequence of holographic exposures over the course of a transition of the film from one swelling state to another. As with WO05/122099, the swelling state of the holographic recording material must be controllable by some means, typically chosen from pH, ion concentration, humidity or water activity.

Using a swellable polymer and recording holographic elements at different states of swelling means that multicolour holograms can be created with a single laser but has the disadvantage of involving subsequent steps of recording which are time-consuming, complicated and costly. Alternatively, holograms having multiple colours can be created using multiple lasers, but this also has the disadvantage of being costly and complicated.

The aim of the invention is to provide a method of producing multicoloured holograms which overcomes the disadvantages of the known methods

### SUMMARY OF THE INVENTION

According to a first aspect, the present invention provides a method of making a product containing a hologram which has at least two replay colours when viewed at a given angle, the method comprising the steps of:
(i) recording holographic elements at each of at least two different angles in a master; and
(ii) copying the master.

According to a second aspect, the invention comprises a product obtainable by a method according to the first aspect of the invention.

The present invention provides a method of making multicoloured holograms using a single laser, without the need to vary the physical state of the substrate on which the hologram is being recorded. This is extremely beneficial as it allows a secure hologram to be produced (in the sense that it is very difficult to forge) by a simple and inexpensive process.

Holograms which have been produced by such a method have unique display characteristics.

### DETAILED DESCRIPTION OF THE INVENTION

Conventionally, commercial products containing holographic images are made using a “master”, from which the hologram is “copied” onto the final product. This is a cost-effective and efficient way of making a product in large quantities, and is used in mass-production of holograms. This process is well known to people skilled in holography.

In the present invention, a master is created which has different holographic elements, having a divergent angle of replay. Once copied onto a product, this gives the appearance of different colours for each element when viewed at a given angle. The colour of the various elements relative to one another is controlled by varying the relative angle of replay between the elements in the master.

The step of recording holographic elements at each of at least two different angles in a master, is preferably achieved using a master which is contoured. In this embodiment, each element of the master is represented by a contoured surface. A laser is preferably used to record the hologram. In this way, when recording the holographic elements in the master, the laser can be fixed and will record a holographic element having a different angle of replay at each element. The shape of the contoured master is selected depending on the variation of colours that is desired on the product. For a product having three colours, the master will be shaped to have three elements which are at angles to one another.

Alternatively, the master may be rotated during recording of the holograms relative to the recording laser so that it is presented to the laser at different angles.

An advantage of the present invention is that, as the master has been produced using a single laser, the copying can also be carried out using a single laser.

The invention is particularly relevant to products which are holographic sensors. A holographic sensor product generally comprises a support medium with the hologram disposed throughout its volume. The support medium interacts with an analyte resulting in a variation of a physical property of the medium such as its polarisability, reflectance, refractance or absorbance. This variation induces an observable change in an optical characteristic of the holographic element. If any change occurs whilst the hologram is being replayed by incident broad band, non-ionising electromagnetic radiation, then a colour change may be observed. With a hologram according the invention, a change in each of the colours will be produced when the hologram is viewed from a given angle.

There are a number of basic ways to change a physical property, and thus vary an optical characteristic. The physical property that varies is preferably the size of the holographic element. This variation may be achieved by incorporating specific groups into the support matrix, where these groups undergo a conformational change upon interaction with the analyte, and cause an expansion or contraction of the support medium. Such a group is preferably the specific binding conjugate of an analyte species. Another way of changing the physical property to change the active water content of the support medium.

A holographic sensor may be used for detection of a variety of analytes, simply by modifying the composition of the support medium. The medium preferably comprises a polymer matrix, the composition of which must be optimised to obtain a high quality film, i.e. a film having a uniform matrix in which holographic fringes can be formed. Suitable sensors are disclosed in WO95/26499, WO99/63408 and WO04/081676.

The holographic effect may be exhibited by illumination (e.g. under white light, UV or infra-red radiation), specific temperature, magnetic or pressure conditions, or particular chemical, biochemical or biological stimuli. The hologram may be an image of an object or a 2- or 3-dimensional effect, and may be in the form of a pattern which is only visible under magnification.

Holograms of the invention may be used to authenticate an article. The hologram may be applied to an article using a transferable holographic film which is, for example, provided on a hot stamping tape. The article may be a transaction card, banknote, passport, identification card, smart card, driving license, share certificate, bond, cheque, cheque card, tax banderole, gift voucher, postage stamp, rail or air ticket, telephone card, lottery card, event ticket, credit or debit card, business card, or an item used in consumer, brand and product protection for the purpose of distinguishing genuine products from counterfeit products and identifying stolen products. The holograms may be used to provide product and pack information for intelligent packaging applications. “Intelligent packaging” refers to a system that comprises part of, or an attachment to, a container, wrapper or enclosure, to monitor, indicate or test product information or quality or environmental conditions that will affect product quality, shelf life or safety and typical applications, such as indicators showing time-temperature, freshness, moisture, alcohol, gas, physical damage and the like. The article may be a tramper-proof label or seal. Alternatively, the hologram can be applied to products with a decorative element or application such as any industrial or handicraft item, including but not limited to items of jewelry, items of clothing (including footwear), fabric, furniture, toys, gifts, household items (including crockery and glassware), architecture (including glass, tile, paint, metals, bricks, ceramics, wood, plastics and other internal and external installations), art (including pictures, sculpture, pottery and light installations), stationery (including greetings cards, letterheads and promotional material) and sporting goods.

### DESCRIPTION OF THE DRAWINGS

FIGS. 1A-1E are schematic diagrams showing the surface relief of a master and the resulting holographic fringes.

The following Examples illustrate the invention.

### Example 1

A master hologram was constructed out of a nickel shim using a logo. The shim had a mirrored background which reflected all light at 4° from the normal. Blue sections of the logo were created to reflect 532 nm light at 45° to the normal, and orange sections were created to reflect 532 nm light at 30° to the normal, giving rise to a master hologram which had elements that reflected different colours when viewed from a specific angle. A contact copy of the master was then created in a gelatine film using a 532 nm laser, and the resulting hologram showed the same colour characteristics as the master.

### Example 2

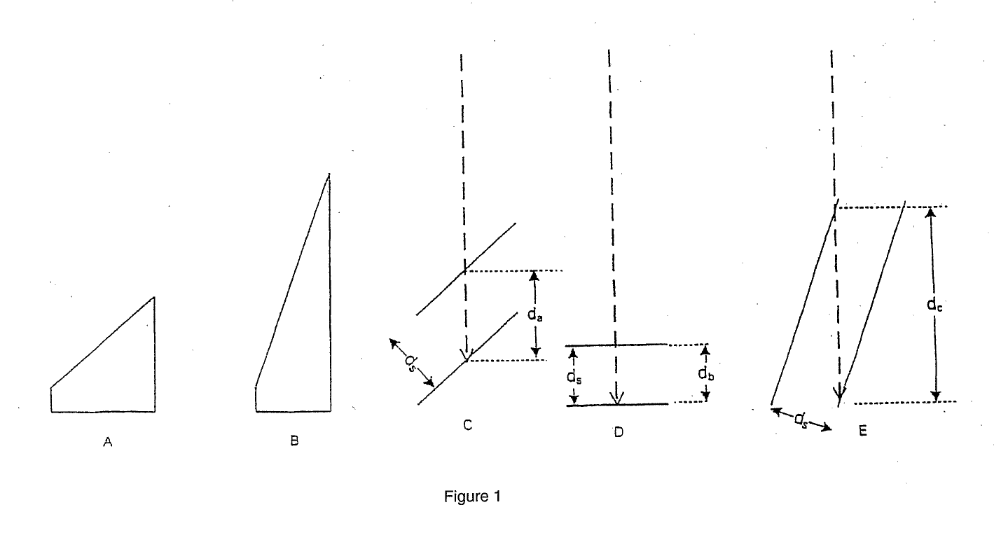

The principle of the system is demonstrated by creating 2 surface relief objects, A and B, as shown in FIGS. 1A and 1B, on top of a mirror background. When a holographic recording medium is placed on top of this surface relief object and then illuminated with a coherent laser beam, interference patterns are recorded and developed within the polymer which describe the relief patters (FIGS. 1C-E). The spacing between the fringes can be approximately described by the Bragg equation:

λ=2 nd cos θ

where θ is the angle of incidence, d is the distance between fringes, λ is the diffraction wavelength and n is the average defraction index in vacuo. Thus, the spacing between fringes, dₛ, is set by the frequency of the laser used and is the same for all of the surface relief objects recorded as well as the background mirror.

When the hologram is now illuminated with white light and viewed normal to the hologram surface, the separation between the fringes relative to the viewing angle then becomes dₐ and dₛ for surface relief objects A and B respectively (FIGS. 1C and 1E) and remains the same for the mirror (FIG. 1D). According to the Bragg equation, this will then result in different frequencies of light or different colours being reflected at each specific viewing angle, giving rise to a hologram with multiple colours at points where the surface relief objects where positioned. The background mirror has the same frequency or colour as the laser used to record the image.

1. A method of making a product containing a hologram which has at least two replay colours when viewed at a given angle, the method comprising the steps of:
(i) recording holographic elements at each of at least two different angles in a master; and
(ii) copying the master.

2. The method according to claim 1, wherein the master is contoured and comprises at least two surfaces which are angled relative to one another.

3. The method according to claim 1, wherein the holographic elements are recorded using a laser.

4. The method according to claim 3, wherein the master is rotated relative to the laser beam during step (i).

5. A product obtainable by a method according to claim 1, containing a hologram which has at least two replay colours when viewed at a given angle.

6. The product according to claim 5, wherein the hologram is generated by the diffraction of light.

7. The product according to claim 5, wherein the hologram is only visible under magnification.

8. The product according to claim 5, wherein the holographic image is of an object or gives a 2- or 3-dimensional effect.

9. The product according to claim 5, further comprising means for producing an interference effect when illuminated with laser light.

10. The product according to claim 9, wherein the means comprises a depolarising layer.

11. The product according to claim 5, wherein the hologram is viewable under white light, UV light or infra-red radiation.

12. The product according to claim 5, wherein the hologram is viewable under specific temperature, magnetism or pressure conditions.

13. The product according to claim 5, having an optical filter thereon.

14. The product according to claim 5, wherein the optical filter is a bandpass filter.

15. The product according to claim 5, wherein the master comprises a dispersive reflective surface.

16. The product according to claim 5, having machine-readable features which are dependent on the specific angle and/or colour of certain optical elements.

17. The product according to claim 5, which comprises a holographic sensor.

18. A method of detection of an analyte in a sample, which comprises contacting the sample with the medium of a sensor according to claim 17, and detecting any change of the optical characteristic.

19. The method according to claim 18 wherein the analyte is a chemical, biochemical or biological species.

20. The method according to claim 18, wherein the change of the optical characteristic is detected using a device selected from an optical reader, a mobile phone, a computer and a digital camera.

21. An article comprising a product according to claim 5.

22. The article according to claim 21, which is a transaction card, banknote, passport, identification card, smart card, driving license, share certificate, bond, cheque, cheque card, tax banderole, gift voucher, postage stamp, rail or air ticket, telephone card, lottery card, event ticket, credit or debit card, business card, or an item used in consumer, brand or product protection for the purpose of distinguishing genuine products from counterfeit products or identifying stolen products.

23. The article according to claim 22, which is an item of intelligent packaging as defined herein.

24. The article according to claim 21, which is an industrial or handicraft item comprising a decorative element, selected from items of jewelry, items of clothing (including footwear), fabric, furniture, toys, gifts, household items, architecture, art, stationery and sporting goods.

25. The article according to claim 21, which is a product or device for use in agricultural studies, environmental studies, human or veterinary prognostics, theranostics, diagnostics, therapy, chemical analysis or petrochemical analysis.

26. The article according to claim 25, which is a test strip, chip, cartridge, swab, tube, pipette, contact lens, sub-conjunctival implant, sub-dermal implant, breathalyser, catheter or a fluid sampling or analysis device.

27. A transferable holographic film comprising a sensor according to claim 17.

28. The film according to claim 27, which is present on a hot stamping tape.

29. A method of enhancing the security of an article, which comprises transferring onto the article the sensor from a film according to claim 27.

30. A system comprising a sensor according to claim 17, which is capable of generating data from the sensor.

31. Use of a system according to claim 30, for storage, control, transmission, reporting and/or modeling of data generated thereby
